(19) United States
(12) Patent Application Publication
(10) Pub. No.: US 2024/0137843 A1
(43) Pub. Date: Apr. 25, 2024

(54) SYSTEM AND METHOD FOR RELIABLE GEOLOCATION COMPUTATION OF COMMUNICATING ENDPOINT DEVICES USING LEO SATELLITE ASSISTANCE

(71) Applicant: WI-LAN RESEARCH INC., Vista, CA (US)

(72) Inventors: Arslan Mumtaz, Islamabad (PK); Zain Noman, Islamabad (PK); Rashad Ramzan, Islamabad (PK); Muddassar Farooq, Islamabad (PK); Kenneth Stanwood, Vista, CA (US)

(73) Assignee: WI-LAN RESEARCH INC., Vista, CA (US)

(21) Appl. No.: 18/311,979

(22) Filed: May 4, 2023

Related U.S. Application Data
(60) Provisional application No. 63/379,178, filed on Oct. 12, 2022.

(51) Int. Cl. H04W 48/04; G01S 19/25; H04W 64/00

(52) U.S. Cl. CPC H04W 48/04; G01S 19/258; H04W 64/00

(57) ABSTRACT

A method and system for computing the geolocation of UEs in a communication system by using LEO satellites. The satellites in this method and system combine only the signals that are transmitted by the communicating endpoints with the information of time of arrival and ephemeris data. A minimum of three or four satellites, based on the method used for computing the geolocation, are required to receive and append the signals transmitted by a UE. An access server of an LBS provider uses the information in the signals to compute the geolocation coordinates of UEs of its client users. Similarly, a UE of a client can also compute the geolocation coordinates of an access server of an LBS provider; as a consequence, both can authenticate each other using a location-based access control method. As a result, both UE and access server can directly authenticate each other using a suitable immutable factor.

### CROSS REFERENCE TO RELATED APPLICATIONS

This application claims priority to U.S. Provisional Patent Application Ser. No. 63/379,178, filed Oct. 12, 2022, titled “SYSTEM AND METHOD FOR RELIABLE GEOLOCATION COMPUTATION OF COMMUNICATING ENDPOINT DEVICES USING LEO SATELLITE ASSISTANCE”, the disclosure of which is incorporated herein by reference.

### FIELD OF THE INVENTION

The disclosed concept described herein discloses a system and method that enables the location-based service provider or an endpoint receiver User Equipment (UE) of a communication session to compute the true geolocation coordinates of a UE of its client user in a communication system based on a non-terrestrial network of low earth orbiting satellites. In an embodiment, a UE could also compute its own geolocation coordinates in a secure and reliable fashion.

### BACKGROUND OF THE INVENTION

Typically, users who want to remotely access premium or sensitive assets or resources of a business/corporation/government through their devices must first authenticate themselves by sharing their identification credentials and then the system allows them access to these assets or resources. Due to the rapid advancements in the technology of high-speed communication networks such as 5G/6G networks and beyond, coupled with exponential growth in the semiconductor industry, it is conservatively estimated that at least trillions of devices (mobiles, IoT devices, laptops, etc.) will exchange an unprecedented amount of data at very high data rates. Furthermore, due to an influx of smart applications on heterogeneous communication devices, businesses and users require secure and low latency authentication systems to gain access to their digital and/or physical assets. Context-aware cognition enabled access control systems and methods require additional information—location, device manufacturer, network type—of a user in addition to his username and password to authenticate him as a legitimate user before granting him access to the resources or services. It is an expectation that the proposed system and method will make it significantly difficult to compromise such intelligent access control systems.

For many applications, such as ridesharing, food delivery, drone delivery, e-health, and e-commerce, it is desirable to ascertain the true geolocation of devices, collectively referred to as user equipment (UE) hereafter. Satellite-based location systems such as the US Global Positioning System (GPS) or the European Global Navigation Satellite System (GNSS), though ubiquitously available, are unable to provide a reliable method to UEs to securely determine their own geolocation, and these systems provide no protection against a compromised device that impersonates the location of some other device or fakes its own geolocation. It is already demonstrated that a malicious entity can transmit fake GPS signals, causing a device to think it to be at a location where it is not. This attack could be applied, for instance, to delivery drones to trick them to deliver their cargo to the wrong location or at a minimum ensure it does not reach the intended recipient. It is desirable to have a system and method that allows a device to be confident of its true geolocation. Moreover, as mentioned before, malicious UEs—the ones running compromised firmware or specialized firmware with backdoors that may have been installed by rogue entities for espionage—could impersonate the location of other UEs or even fake their own location to Location-based Service (LBS) providers. As a result, LBS providers could grant access to premium assets, resources, and services to malicious entities once they impersonate the geolocation or ID of legitimate users or devices; and this may eventually compromise the complete network system of an organization.

The method described in “Secure Location of Wireless Devices Using LEO Satellite Assistance”, that is a co-pending U.S. patent application Ser. No. 17/862,728 (which is included by reference) proposes a novel method to compute the geolocation of a UE. However, the proposed method requires high memory and processing power in the satellite nodes. Currently deployed satellite nodes may not be able to support such computations due to limited memory and computational power. To enable the reliable location-based services, a system and method that allows the location-based service provider to compute the geolocation of UEs of its client users is herein disclosed.

### SUMMARY

A method and system that enables the location-based service (LBS) provider or endpoint receiver UEs to compute the geolocation of UEs of its client users in a communication system based on low earth orbiting (LEO) satellites is described. The method accommodates scenarios such as limited memory and low computational power in the satellite nodes; or privacy and security laws under which satellites may not be allowed to compute the geolocation of devices in certain jurisdictions. As a result, a system and method are disclosed in which satellites append the received data frames with the time of arrival and other required information to recipient devices or location-based servers on the ground.

In the disclosed concept, a UE transmits a resource access request to a plurality of LEDs. The serving satellite receives and forwards the resource access request transmitted by the UE to the serving satellite of a location-based service provider either directly or by routing it through the satellite network. The LBS requests the scheduling of a positioning signal opportunity for the UE to CMS MAC Coordinator. Consequently, the UE of a client user transmits the positioning signal based on the scheduling information. A minimum of three or four satellites, depending on the method used for computing the geolocation, are required to receive and transmit the appended positioning signal after inserting time of arrival and ephemeris data to the position computation entity (PCE) of access server of an LBS provider. An access server might consist of one server or a cluster of servers, either on premise or in the cloud, that is responsible for authenticating devices by using an immutable factor that contains geolocation signature as a factor as well. Satellites that receive and append the positioning signal form a cluster and members of such cluster are termed as cluster member satellites (CMSs). The CMSs that directly receive the positioning signal package it in a data-frame including the time of arrival of the positioning signal and their ephemeris data. In scenarios, where PCE of a LBS provider does not belong to the coverage area of CMSs that directly receive the positioning signal from a UE of a client user, the data-frame including the positioning signal, the information of its time of arrival, and ephemeris data of CMSs that directly received the positioning signal will be transmitted to a CMS that lies in the coverage space of a PCE of the LBS provider or the recipient device. PCE of LBS provider uses the information received in the signal to compute the geolocation coordinates of the UE of its client user. The resource access request is granted or denied based on a verification of immutable factor methods described in a co-pending U.S. patent application 63/350,498titled “A Novel Authentication System and Method Using an Immutable Factor Comprised of Secure device ID and Geolocation Computed by Satellite LEO Assistance”.

In an embodiment, a UE of a client user can also compute the geolocation coordinates of PCE of an LBS provider to authenticate the LBS provider. It is assumed that the geolocation of the access server of a LBS provider is typically static and is already publicly known. This fact can be used to mitigate the malicious activity that can be carried out by entities impersonating LBS providers such as banking servers and e-commerce systems. To compute the geolocation of the access server of an LBS provider, a UE of a client user computes the geolocation from the information obtained by a network of CMSs that provide a positioning signal opportunity to the access server of the LBS. The secure device ID (SDID) in the immutable factor can be verified by communicating with a ground-based authentication system.

In an embodiment of the disclosed concept, if UEs of client users and the access servers of LBS providers or endpoint users are not equipped with the Secure Positioning Enclave (SPE) module described in the co-pending U.S. patent application 63/322,760 (which is included by reference) titled “The method described in “A Secure Hardware System and Method for Geolocation Computation”, the serving CMS is required to append the Tx Time Advance in the appended positioning signal along with the time of arrival and ephemeris data. Two other CMSs that may directly receive the positioning signal from a UE of a client user also include the time of arrival and their ephemeris data and transmit the appended positioning signal to a PCE of the access server of an LBS provider. The PCE of the access server of an LBS provider uses the information contained in the received signals to compute the geolocation coordinates of a UE of its client user.

In scenarios where both the UE of client users and the PCE of the access server of an LBS provider are equipped with an SPE module, client user UEs and the PCE of the access server of an LBS provider are required to transmit the clock signal and their SDIDs from their SPE module to one another to compute geolocation securely and reliably at the endpoint, eliminating the need for LEO satellites to execute the geolocation computation method. These clock signals and SDIDs are transmitted by CMSs to the PCE of the access server of an LBS provider after appending with the information of time of arrival of clock signals and SDIDs at three CMSs from UE of the client user that directly received the clock signal and SDID. The PCE of the access server of an LBS provider receives the three appended clock signals and by using them computes the ToF which can then be used to securely and reliably compute the geolocation of client UEs. In an embodiment, where the CMSs are not equipped with a SPE module, the synchronization messages are forwarded by a CMS network to synchronize the clock signal between a UE of a client user and the PCE of the access server of an LBS provider. Alternatively, if CMSs do contain a SPE module, then each UE may synchronize their clock signals with their respective CMSs. Furthermore, the UE of a client user and the PCE of the access server of an LBS provider can synchronize their clock signals with their respective ground stations.

### BRIEF DESCRIPTION OF THE DRAWINGS

The accompanying drawings, which are incorporated in and constitute part of this specification, illustrate embodiments of the disclosed concept and, together with the description, serve to explain the principles of the disclosed concept. The embodiments herein illustrate the disclosed concept for NTN composed of LEDs; however, it can be adapted to other NTNs such as those using unmanned aircraft systems (UAS) or high-altitude platforms (HAPs). Furthermore, the embodiments illustrated herein are presently preferred, it being understood by those skilled in the art, however, that the disclosed concept is not limited to the precise arrangements and instrumentalities shown, wherein:

FIG. 1 is a system-level illustration of an embodiment of the disclosed concept where the position computation entity resides in a server of a location-based service (LBS) system and a satellite network forwards the signals transmitted by a UE of a client user in the system;

FIG. 2 is a system-level illustration of an embodiment of the disclosed concept where a UE of a client user may also authenticate the access server of an LBS provider by using a suitable immutable factor;

FIG. 3 is a protocol ladder diagram illustrating a method of geolocation computation used by the PCE of the access server of an LBS provider by using the information of Tx Time Advance and Tₐᵣᵣᵢᵥₐₗ in the signal transmitted by a CMS network;

FIG. 4 shows an embodiment of data-frames of the appended positioning signal transmitted by the serving CMS and other CMSs in a CMSs network and data-frames received by the PCE of the access server of an LBS provider;

FIG. 5 is a flowchart illustrating a verification method of geolocation coordinates, computed using information of Tx Time Advance, by the PCE of the access server of an LBS service provider using Time Difference of Arrival (TDOA) method;

FIG. 6 is a protocol ladder diagram illustrating the exemplary messages exchange in a system where a UE of a client user of a system and the PCE of the access server of an LBS provider are equipped with a secure positioning Enclave (SPE) module and CMS s are used to append the received clock signals with the information of time of arrival;

FIG. 7 describes error in the clock signal synchronization due to the difference in the ToF of positive edge indication signal transmitted by a UE of the client user and the ToF of the positive edge indication signal transmitted by the access server of an LBS server;

FIG. 8 illustrates the method for computing the difference in distance between a UE of the client user and serving CMS due to the mobility of serving CMS in its orbit.

FIG. 9 illustrates different angles, used in the system, for a serving CMS during the clock synchronization scenario;

FIG. 10 shows the erroring in clock synchronization due to the mobility of the serving CMS of the UE of a client user;

FIG. 11 shows the erroring in clock synchronization due to the mobility of the CMS of the access server of an LBS provider;

FIG. 12 is a functional block diagram of a secure positioning enclave that transmits the clock signal and computes the geolocation coordinates using the waveform of a received signal that contains the appended clock signal;

FIG. 13 illustrates an embodiment for the structure of the data frame of appended clock signals containing the clock signals and synchronization signals according to an aspect of the disclosed concept;

FIG. 14 illustrates the method used in a clock signal correlator to compute ToF by performing time delay analysis on the clock signal that is transmitted by a UE of client user to the PCE of the access server of an LBS provider and vice versa;

FIG. 15 describes is a flowchart of a method for computing geolocation coordinates of a UE of a client user by the PCE of the access server of an LBS provider using a system in which a UE of client user and an access server of a LBS provider are both equipped with a SPE module;

### DETAILED DESCRIPTION

The figures and their corresponding embodiments provided in this disclosure are aspects of the present disclosed concept, and their advantages may be understood by referring to the figures and the following description. The descriptions and features disclosed herein can be applied to accurately determine the geolocation of UE of client users by Position Computation Entity (PCE) of location-based service providers in NTNs deployed using LEDs. However, it can be adapted to other NTNs such as those using UAS or HAPs. Henceforth, the figures and embodiments depicted are for the sole purpose of clarity and by any means do not limit the scope of the disclosed concept.

In addition, the following abbreviations shall have the following meanings as used herein: LEO—Low earth orbiting; NTN—Non-terrestrial network; UE—User equipment; 3GPP—Third-generation partnership project; GPS—Global positioning system; GNSS—Global navigation satellite system; CMS—Cluster member satellite; ToF—Time of flight; UAS —Unmanned aircraft system; HAP—High altitude platform; SPE—secure positioning enclave; CSM—clock signal manager; CSA—clock signal analyzer; SDID—Secret device ID; PCP—Position Computing Processor; SCSG—Stable Clock Signal Generator; CSP—Clock Signal Processor;

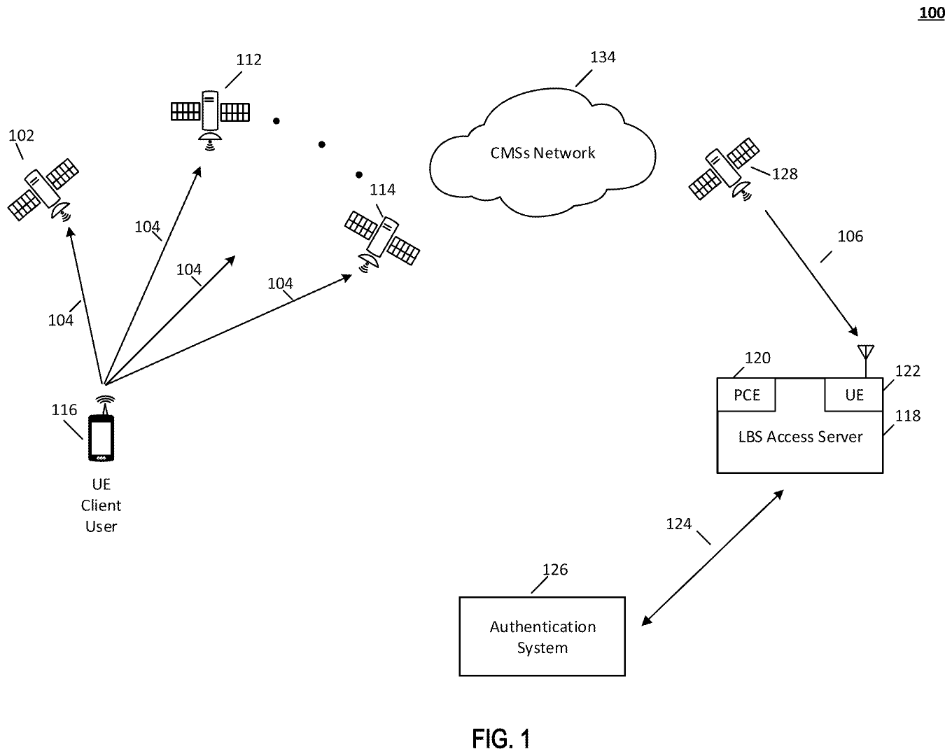

FIG. 1 is a system-level illustration of an embodiment of the disclosed concept where a PCE resides in or is associated with the access server of a location-based service (LBS) providing system, and a satellite network forwards the signals transmitted by a UE of a client user in the system. The signals received by the PCE of access server of an LBS provider will have the information required to compute the geolocation of a UE of a client user, based on the method used and including satellite position and signal reception timing information. The method can be deployed in communication systems based on non-terrestrial networks that use satellite nodes having low computational power. It may be used in jurisdictions where privacy and security laws prohibit satellite nodes from computing the geolocation of devices. These satellite nodes can be LEDs, UAS, or HAPs based on drones or other systems. In FIG. 1, UE 116 of a client user is a device that is connected through a communication network, consisting of LEDs, to an access server 118 of LBS provider that requires authenticating geolocation coordinates of its client users. A minimum of three or four satellites, based on the method used for computing the geolocation coordinates, are required to receive positioning signal 104 transmitted by UE 116 of a client user and append timing and position information and then send it to the PCE 120 of LBS access server 118 via access UE 122. Access UE 122 is preferably stationary, may be internal or external to LBS access server 118, and may have an antenna internal or external to any building that may be housing LBS access server 118. A satellite that receives and forwards a positioning signal from a particular UE 116 belongs to a cluster for that UE, and satellites in this cluster are termed cluster member satellites (CMSs). CMSs are represented by 102, 112, and 114 respectively. Each of CMSs 102, 112, and 114 will receive positioning signal 104, likely at different times, and must forward its contents and append their respective time of arrival (Tₐᵣᵣᵢᵥ) of positioning signal 104 and their own position information to data frame 106 sent to PCE 120. The serving CMS may also append a representation of when positioning signal 104 was expected to be transmitted by UE 116. In an aspect, received signal 104 may be amplified to transmit it to a PCE of LBS access server 118. In another aspect, the signal is amplified by access UE 122 using link budget analysis to avoid any further amplification by CMSs. In a configuration, where access UE 122 of access server 118 of LBS provider does not lie in the coverage zone of the cluster of CMSs (e.g., 102, 112, 114) that directly receive positioning signal 104, CMSs that directly receive the positioning signal will forward the appended positioning signal to a CMS serving access UE 122 of access server 118 of LBS provider. CMSs network 134 represents the intermediate CMSs that receive the signal from CMSs 102, 112, and 114 or others (e.g., via side-link communications) and forward it to CMS 128 serving access UE 122 of LBS provider. CMS 128 transmits appended positioning signal 106, to PCE 120 of LBS access server 118 and it computes the geolocation coordinates of UE 116 of its client user.

To authenticate the identity of the UEs, ground-based authentication system 126 is used in the system as described in the co-pending U.S. patent application 63/350,498 titled “A Novel Authentication System and Method Using an Immutable Factor Comprised of Secure device ID and Geolocation Computed by Satellite LEO Assistance”. UE 116 of a client user should communicate its secret device ID (SDID) in signal 104 in an encrypted manner to be authenticated by LBS provider. Access server 118 of LBS provider transmits an authentication message containing the SDID on communication link 124 to authentication system 126, which houses a database comprised of the SDIDs of all client UEs 116 corresponding to the public IDs. Authentication system 126 decrypts the authentication message and recovers the SDID. If the publicID accompanying the recovered SDID matches the publicID that is stored for the recovered SDID in the database of authentication system 126, then authentication system 126 transmits a flag or a message that indicates that UE 116 is authenticated to LBS access server 118. Thus, a LBS access server 118 can authenticate the immutable factor described in the above referenced co-pending US patent application.

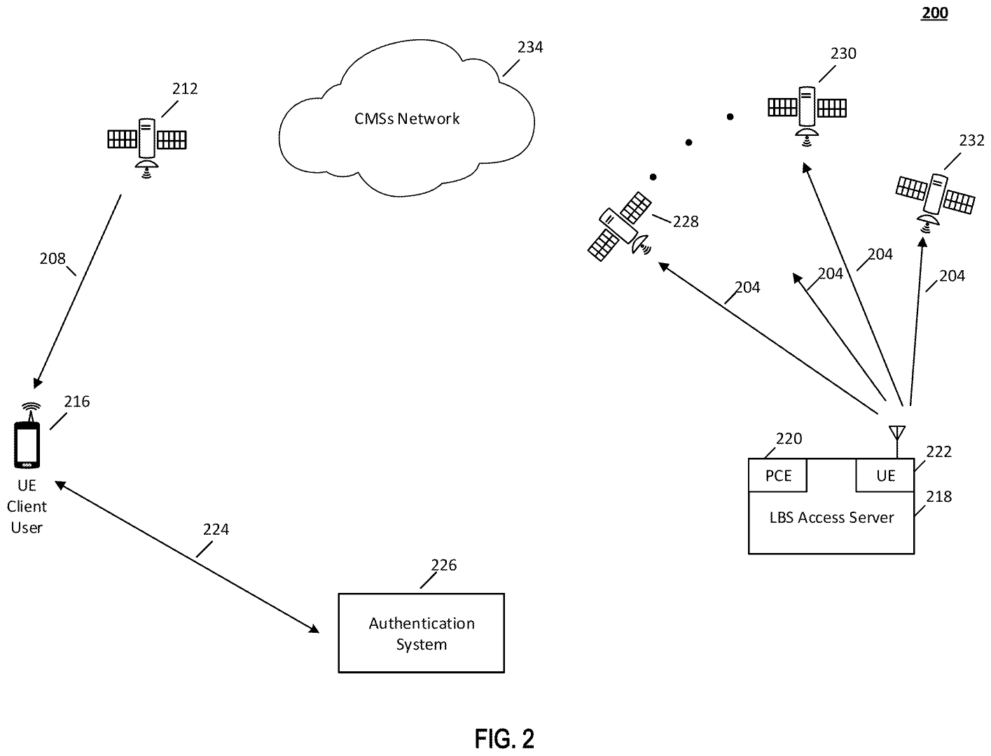

FIG. 2 is a system-level illustration of an embodiment of the disclosed concept where UE 216 of a client user can also authenticate an LBS access server 218 of the LBS provider using a suitable immutable factor. This method ensures that UE 216 of a client user is connected to real (and not impersonated) access server 218 of its LBS provider. It is assumed that the geolocation of a LBS access server 218 is typically static and publicly known, and this fact can be used to mitigate malicious activity that can be carried out by impersonating LBS access server 218 such as banking servers and e-commerce systems. According to this aspect of the disclosed concept, geolocation coordinates of the access server 218 of a LBS provider may be computed by UE 216 of a client user by extracting relevant information from positioning signal 204 that is transmitted by a UE 222 of LBS provider access server 218. Positioning signal 204 of UE 222 of LBS provider server is received by a minimum of three CMSs 228, 230, and 232. CMSs 228, 230, and 232 append time of arrival, their position information, etc. and transmit the appended positioning signal through CMS network 234 to CMS 212 having UE 216 in its coverage space and acting as the serving CMS for UE 216. UE 216 receives appended positioning signal 208 comprised of signal 204 and the information contained in it that can be used by UE 216 of a client user to compute the geolocation of a UE 222 of LBS provider access server 218. UE 216 can also authenticate the SDID of a UE 222 of LBS provider access server 218 by using authentication system 226. UE 216 transmits the SDID on link 224 to authentication system 226, which has the database comprising of SDIDs of UEs 222 of LBS provider access servers corresponding to their publicIDs that may be advertised in signal 204. The authentication status of a UE 222 of LBS provider access server 218 is transmitted to UE 216 through connection link 224.

According to an aspect, the communicating end users can be other than the client and server in a location-based service providing systems. In such scenarios, the geolocation of the communicating end users can be used as a factor of authentication in an end-to-end communication system.

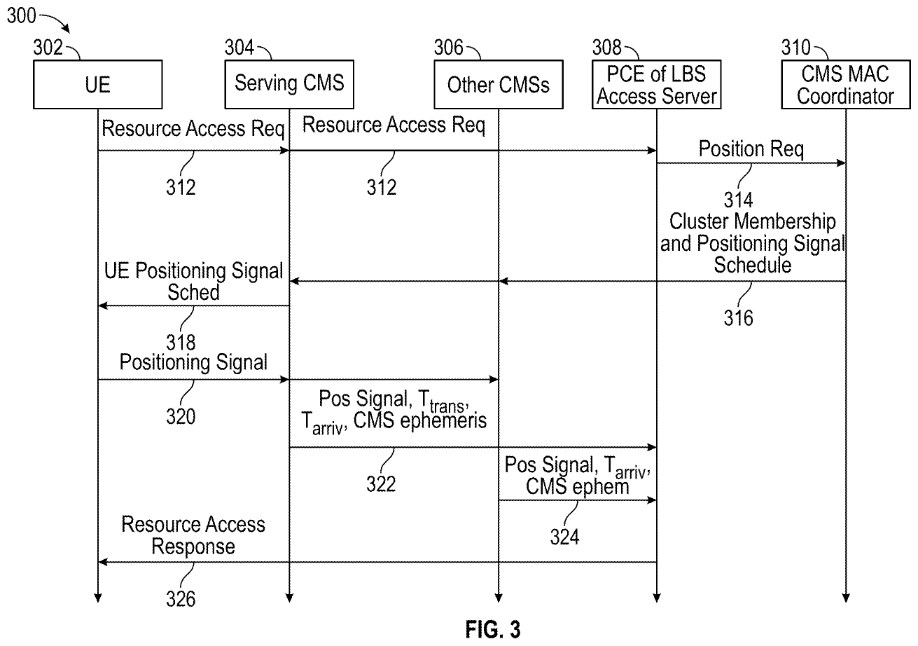

FIG. 3 is a protocol ladder diagram illustrating the exemplary exchange of messages in a method of geolocation computation, employed by a PCE 120 of LBS provider access server 118, using the information of Tx Time Advance and T Arrival in a signal forwarded by a CMSs network. Tx time advance is required to ensure that the downlink and uplink subframes of UE 116 are synchronized at the Serving CMS. The method enables the authentication of two communicating entities by computing the geolocation of one another in scenarios where the endpoint UEs are not equipped with SPE. In FIG. 3, UE 302 of a client user transmits resource access request 312 through a communication network of satellites, comprised of at least serving CMS 304 and other CMSs 306, to the PCE of an access server 308 of LBS provider. The PCE of an access server 308 of an LBS provider makes a positioning request 314 to CMS MAC Coordinator 310. Depending upon where the CMS MAC Coordinator 310 resides with respect to the LBS access server 308, position request 314 may be transmitted via serving CMS 304, client UE 302, the Internet or some other suitable route. The particular route is implementation dependent and does not detract from the use of the disclosed concept. CMS MAC Coordinator 310 determines cluster membership and positioning signal schedule, as described in co-pending patent application 63/266,487 and transmits it in a message 316 to serving CMS 304 and other CMSs 306. Serving CMS 304 forwards e UE positioning signal schedule 318 portion to UE 302 of a client. UE positioning signal schedule 318 indicates when the positioning signal is to arrive at serving CMS 304. The serving CMS 304 maintains Tx Time Advance for transmissions from client UE 302 to serving CMS 304. Serving CMS 304 may maintain Tx Time Advance for UE 302 in more than one way. For instance, in an embodiment serving CMS 304 may send absolute values of Tx Time Advance to UE 302. This embodiment may be preferable when UE 302 is not trusted. In an alternate embodiment, serving CMS 304 may send incremental changes to Tx Time Advance to UE 302 and have UE 302 give the current absolute Tx Time Advance in the positioning signal 320. This embodiment may be preferred when the UE 302 is trusted and there is a desire to save bandwidth used by Tx Time Advance changes messages and positioning signal 320. At the scheduled time, UE 302 sends positioning signal 320 Tx Time Advance amount of time earlier than the time the UE positioning signal schedule indicated for its arrival at serving CMS 304. A minimum of three CMSs, including serving CMS 304, are required to receive positioning signal 320 directly and determine the T_{Arrival} of positioning signal 320 transmitted by UE 302 of a client user. Serving CMS 304 will include at least the information Tx Time Advance or Tₜᵣₐₙₛ derived from Tx Time Advance, T_{Arrival} of positioning signal 312 and its ephemeris data at time T_{Arrival} in data-frame 322 directly to the PCE of an access server 308 of an LBS provider if the PCE 306 of LBS provider lies in the coverage area of serving CMS of UE 302. At least two other CMSs 306 are required to include the information of T_{Arrival} of positioning signal 312 along with their ephemeris data at time T_{Arrival} in data-frame 324 and transmit it to the PCE of an access server 308 of an LBS provider. If the PCE of an access server 308 of an LBS provider is not in the coverage area of CMSs that directly receive positioning signal 320, data-frame 322 from the serving CMS and data-frame 324 from other CMSs 306 are transmitted to the serving CMS for the UE 122 of LBS provider in its coverage area. The PCE of an access server 308 of an LBS provider computes the geolocation of UE 302 by extracting relevant information from data-frames 322 and 324 and then running the trilateration method. Resource access response 326 is communicated to UE 302 through CMS network.

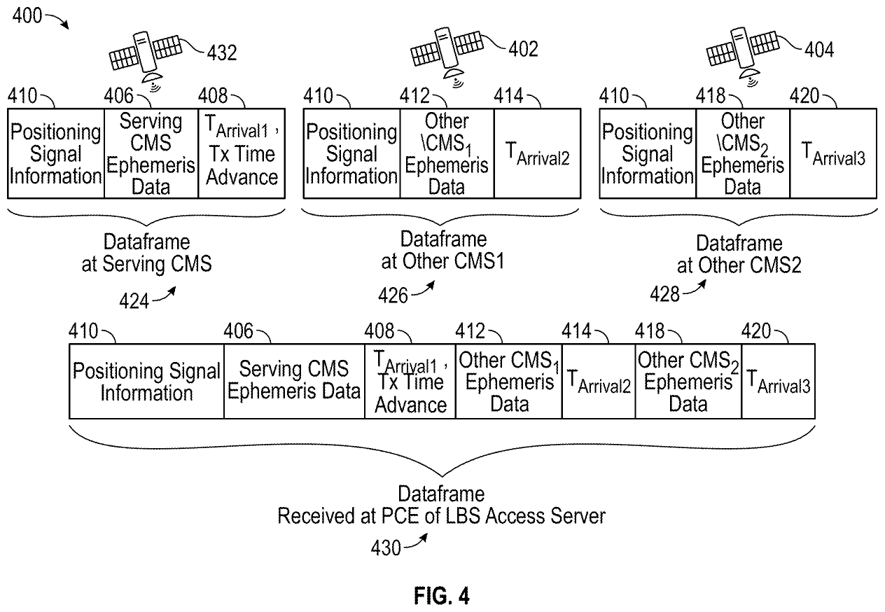

FIG. 4 shows an embodiment of data-frames of the data-frames transmitted by the serving CMS 432 and other CMSs 402 and 404 and received by a the PCE of an access server 308 of an LBS provider. Data-frame 424 contains positioning signal information 410 of UE 302, information 408 about its Tx time Advance and T_{Arrival} of positioning signal, and ephemeris data 406 of serving CMS 432. Data-frame 426 is transmitted by first other CMS 402 and is comprised of positioning signal information 410, T_{Arrival2} 414 of positioning signal, and its ephemeris data 412. Data-frame 428 is transmitted by second other CMS 404 and is comprised of positioning signal information 410, the T_{Arrival3} 420 of positioning signal at CMS 404, and its ephemeris data 418 at T_{Arrival3} 420. In an alternate embodiment, data-frames 424, 426, and 428 may be collected, for instance by serving CMS 432 or the serving CMS of LBS UE 122 if different and combined into data-frame 430. Data-frame 430 may be transmitted to the PCE of an access server 308 of an LBS provider and contains information of Tx time advance, T_{Arrival} at each of the at least three CMSs, the ephemeris data of the CMSs, and positioning signal information 410.

The ephemeris data is composed of, for example, the position and velocity of a CMS. Other relevant information, such as estimated future locations, may also be included. Velocity may be used to reduce the uncertainty that is caused by a different T_{Arrival} at each CMS. The position and velocity may be expressed in any standard format.

In an embodiment, a verification of the geolocation computed using the information of Tx time advance information above may be performed by the PCE of an access server 308 of an LBS provider using the TDOA method. The method of geolocation computation that uses the Tx time advance is prone to attacks when a malicious entity (e.g., malicious firmware) manipulates the timing of positioning signal 318 within the window of positioning signal opportunity causing serving CMS 304 to compute an incorrect Tx Time advance at a serving CMS as described in the co-pending U.S. patent application 63/322,760 titled “A System and Method to Detect the Malicious Activity in the Positioning Signal using a Positioning Comparator”. In these scenarios, the PCE of an access server 308 of an LBS provider may desire to verify the geolocation that was computed by using the method in FIG. 3. In an embodiment, the PCE of an access server 308 of an LBS provider can verify the trilateration-based geolocation computed with Tx time advance and T_{Arrival} on three satellites with the geolocation computed by using the method of time difference of arrival (TDOA) of the positioning signal at minimum of four CMSs. The PCE of an access server 308 of an LBS provider includes in the position request 314 to CMS MAC Coordinator 310 an indication that it requires measurements from at least four CMS s. CMS MAC Coordinator 310 transmits cluster membership and position signal scheduling information 316 for geolocation verification using TDOA to a minimum of four CMSs that are able to directly receive positioning signal 320 from UE 302. These four CMSs transmit their respective data-frames, 322 for serving CMS 304 and 324 for the other CMSs 306, to the PCE of an access server 308 of an LBS provider which will use the TDOA based geolocation verification.

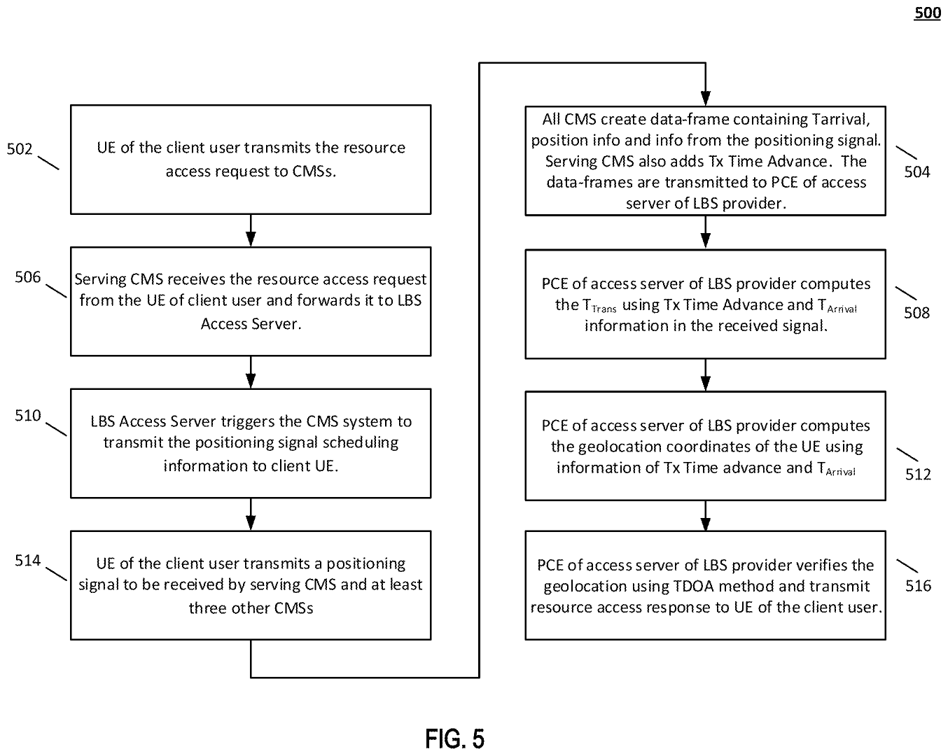

FIG. 5 is a flow graph of the system that illustrates the steps for geolocation computation by the PCE of an access server 308 of an LBS provider. It is used when there may be suspicion that Tx Time Advance has been manipulated to disguise the UE's 302 location. In step 502, UE 302 of a client user transmits resource access request 312 to its serving CMS 304 in the CMS network. Serving CMS 304 of UE 302 of a client user forwards resource access request 312 to the PCE of an access server 308 of an LBS provider via the CMS network in step 506. In step 510, the PCE of an access server 308 of an LBS provider transmits position request 314 to CMS MAC Coordinator 310 triggering it to provide the cluster membership and positioning signal schedule 316 to the CMS. This, in turn causes serving CMS 304 to forward positioning signal schedule to UE 302, also in step 510. Positioning signal scheduling information 318 informs UE 302 about the transmission time and frequency of positioning signal 320. In step 514, UE 302 transmits positioning signal 320 that is received by serving CMS and at least three other CMSs. In step 504, serving CMS 304 of UE 302 creates a data-frame 322 containing T_{Arrival}, Tx time advance, its own position, and data from positioning signal 320 of UE 302, while the at least three other CMSs each create a data-frame 324 containing T_{Arrival}, their own position, and data from positioning signal 320 and forward the data-frames to the PCE of an access server 308 of an LBS provider. In step 508, the PCE of an access server 308 of an LBS provider computes T_{Trans} as T_{Trans}=(T_{Arrival}−Tx time advance) where T_{Arrival} is from serving CMS 304 not one of the other CMSs 306. One skilled in the art would understand that T_{Trans} could be calculated by serving CMS 304 or UE 302 without changing the disclosed concept. In step 512, the PCE of an access server 308 of an LBS provider computes the geolocation coordinates of UE 302 using the calculated T_{Trans} and each CMSs T_{Arrival} and position information. In step 516, the PCE of an access server 308 of an LBS provider verifies the geolocation using the TDOA method. If the two calculated geolocations are within a threshold distance of each other, UE 302 is verified (pending other checks such as proper SDID) and LBS access server 308 transmits resource access response 326 indicating success to UE 302 via the CMS network. If, however, the two calculated geolocations are not within a threshold distance of each other, UE 302 is rejected and the PCE of an access server 308 of an LBS provider transmits resource access response 326 to UE 302 indicating failure.

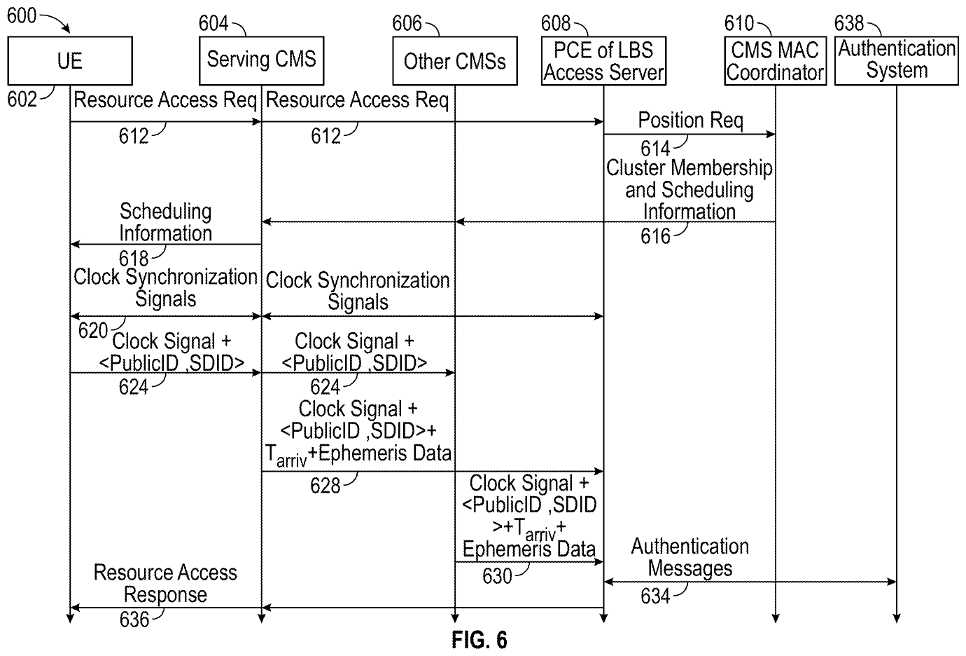

FIG. 6 is a protocol ladder diagram illustrating the exemplary message exchange in a system where UE 602 and the PCE of an access server 604 of an LBS provider are equipped with a secure positioning enclave (SPE) module. In this embodiment, CMSs do not have SPE module but are required to append the clock signal or other synchronization signals received from UE 602 with the information of time of arrival. SPE module generates the waveform of a clock signal that can be used to determine the geolocation of UE. In a system where service providing entities such as LBS provider requires UE 602 to authenticate itself using an immutable factor comprised of <publicID, SDID, geolocation>, UE 602 transmits resource access request 612 to the PCE of an access server 608 of an LBS provider through its serving CMS 604. PCE of an access server 608 of an LBS provider transmits position request 614 to CMS MAC Coordinator 610

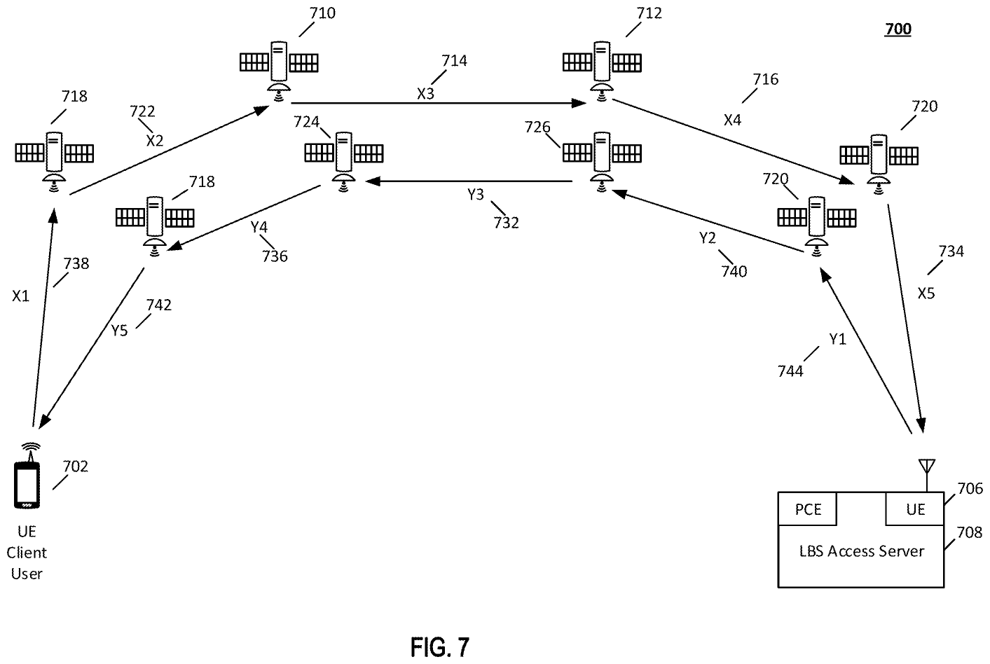

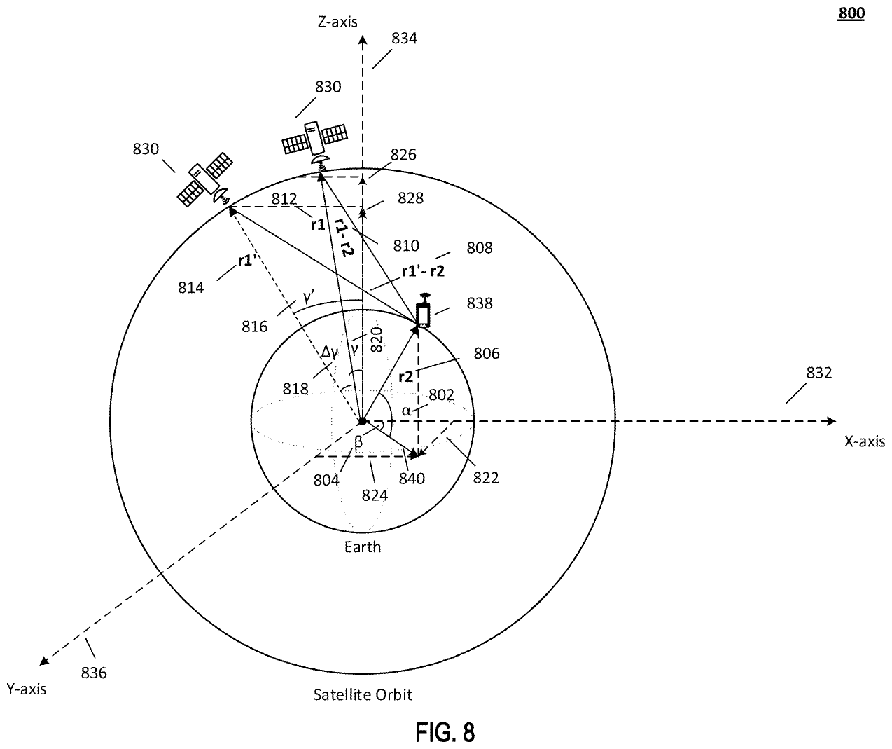

PCE of an access server 608 of an LBS provider makes a positioning request 614 to CMS MAC Coordinator 610. The positioning request specifies that the method for geolocation computation is based on secure positioning enclave. Depending upon where the CMS MAC Coordinator 610 resides with respect to the LBS access server 608, position request 614 may be transmitted directly or via some other route as described earlier. The particular route is implementation dependent and does not detract from the use of the disclosed concept. CMS MAC Coordinator determines cluster membership and scheduling information 616 and transmits it in a message 616 to the serving CMS 604 and other CMSs 606. Serving CMS 604 forwards the scheduling information 618 to UE 602. Scheduling Information 618 contains the schedule for the synchronization of clock signal generated from the SPE module of UE 602 and SPE module of access server 608 of an LBS provider and schedule for UE 602 to transmit the clock signal from its SPE module that can be used to compute the geolocation. For clock signal synchronization, UE 602 and access server 608 of the LBS provider follow the two-way transfer of positive edge indication signal as described in the co-pending U.S. patent 63/322,760 in protocol message clock synchronization signals 620. Due to the mobility of serving CMS 604 and other CMSs 606 during the forwarding of the message clock synchronization signals 620, the offset between the clock signal generated by UE 602 and clock signal generated by access server 608 of an LBS provider cannot be computed accurately. The formal error models for the offset of the clock signal are derived and illustrated in FIGS. 7 and 8. In one embodiment, these errors can be removed if the serving CMS of UE 602 and access server 608 of an LBS provider can compute the angle of arrival of the signal from UE 602 and access server 608 of an LBS provider. In another embodiment, these errors can be mitigated by using a dedicated channel of GEO satellites for the computation of the offset between clock signals. In another embodiment, UE 602 and access server 608 of an LBS provider follow the two-way positive edge indication signal transmission method for computing offset with their respective ground stations. In this embodiment, the clocks of ground stations are synchronized with one another.

Once the offset between the clock signal of UE 602 and the clock signal of the access server 608 of an LBS provider is computed using clock synchronization signals 620, UE 602 transmits the clock signal generated by SPE module of UE 602 and its <PublicID, SDID> in message 624. Serving CMS 604 and other CMSs 606 receive message 624 and include the time of arrival of message 624 and their ephemeris data before forwarding it to the access server 608 of an LBS provider. Access server 608 of an LBS provider receives messages 628 and 630 containing clock signal, <PublicID, SDID >, ephemeris data and the time of arrival from serving CMS 604 and other CMSs 606 directly or from any other route that depends on the distance between the two communicating UEs. Access server 608 of an LBS provider correlates a minimum of three clock signals with the clock signal generated by its own SPE module. The difference in the positive edges of the received clock signal from the clock signal generated locally may be used in combination with the information of time of arrival of the clock signal at three CMSs, that directly received the clock signal from UE 602 along with the information regarding offset computed using message 620, can be used to compute three time of flights. The information of time of flights and ephemeris data of CMSs are used by access server 608 of an LBS provider to compute the geolocation coordinates of UE 602. Access server 608 of an LBS provider exchange authentication messages 634 with Authentication System 638 to authenticate UE 602 with its SDID. Once the authentication is completed, access server 608 of an LBS provider transmits the resource access response 636.

The clock synchronization method assumes ToF of positive edge indication signal from UE 602 to serving CMS 604 and from serving CMS 604 to UE 602 are the same. However, in the scenario of the present disclosed concept, there exist multiple LEO satellite nodes, between UE 602 of a client user and access server 608 of an LBS provider, that are moving at high orbital velocities. Therefore, it is highly likely that ToF of the positive edge indication signal forwarded from UE 602 of a client user to LBS provider access server 608 will be different from the ToF of the positive edge indication signal transmitted by access server 608 of an LBS provider to UE 602 of a client user. In such circumstances, the error in the synchronization of the clock signals of UE 602 and access server 608 of an LBS provider is a function of the difference in the ToF of the positive edge indication signal from UE 602 to access server 608 of an a LBS provider.

FIG. 7 illustrates an embodiment where there is error in the clock signal synchronization when the ToF of positive edge indication signal transmitted by UE 702 of a client user to access server 708 is different from the ToF of the positive edge indication signal transmitted by access server 708 to UE 702. For this embodiment, it is assumed that satellites do not have SPEs. Positive edge indication signal transmitted by UE 702 of a client user is received by its serving CMS 718 after ToF of X1 738, where X1 738 represents the distance covered by the positive edge indication signal from UE 702 to CMS 718 with speed c that is the speed of the light. In this example scenario, UE 706 of LBS provider access server 708 does not lie in the coverage area of serving CMS 718 of UE 702; therefore, the positive edge indication signal along with T_{Arrival} must be forwarded by serving CMS 718 directly or via other CMSs to serving CMS 720 of access server 708 of an LBS provider. In FIG. 7, the positive edge indication signal from UE 702 is forwarded by CMSs 718, 710, 712 and 720 enroute to access server 708 with total ToF calculated as (X1 738+X2 722+X3 714+X4 716+X5 734)/c. In FIG. 7, X2 722 is the distance between CMS 718 and CMS 710, X3 714 is the distance between CMS 710 and CMS 712, X4 716 is the distance between CMS 712 and CMS 720. Access server 708 of an LBS provider, after receiving positive edge indication signal from UE 702 of a client user, enables its counter according to the clock synchronization method described in “A Secure Hardware System and Method for Geolocation Computation”. Access server 708 of an LBS provider stops its counter after detecting the positive edge of the clock signal generated inside SPE module and transmits its positive edge indication signal to UE 702.

Due to continuous mobility of LEO satellites, serving CMS 720 of access server 708 of an LBS provider might have moved to a different position when it receives positive edge indication signal from access server 708 from the position when it forwarded the positive edge indication signal of the UE 702 to access server 708. The change in position of serving CMS 720 of access server 708 is a function of the time elapsed between the time instant the positive edge indication signal of UE 702 is forwarded by serving CMS 720 to access server 708 and the time instant the positive edge indication signal of the LBS access server 708 is received by the serving CMS 720 of UE 706.

The positive edge indication signal transmitted by LBS access server 708 is received by its serving CMS 720 after ToF of Y1/c. Y1 is the distance between access server 708 and the new position of serving CMS 720 when it receives the positive edge indication signal from LBS access server 708. The positive edge indication signal from LBS access server 708 to UE 702 may take a different route due to the mobility of satellites and hence will have a different ToF compared to the ToF of the positive edge indication signal from UE 702 to LBS access server 708. The ToF of the positive edge indication signal from LBS access server 708 to UE 702 is therefore computed as (Y1 744+Y2 740+Y3 732+Y4 736+Y5 742)/c. In this example scenario, we have assumed that serving CMS 718 of UE 702 and serving CMS 720 of access server 708 do not change during two-way transfer of positive edge indication signal even though their positions might have changed due their orbital motion. However, this assumption, does not limit the functionality of the system and method and can extend to the scenario when serving CMS s might have changed. As each CMS is required to forward the positive edge indication signal by inserting the T_{Arrival}; therefore, the ToF of the positive edge indication signal between satellites is computed with high accuracy.

The maximum offset between the clock signal of UE 702 and access server 708 cannot exceed pulse repetition period of the clock signal. To compute the geolocation of a UE, pulse repetition period of the clock signal of a UE should be slightly greater than the maximum ToF from UE to its serving CMS. Therefore, the ToF of the positive edge indication signal from UE 702 to LBS access server 708 will always be greater than the ToF of the positive edge indication signal from UE 702 to its serving CMS 718. Thus, the ToF of positive edge indication signal from UE 702 to access server 708 will always be greater than the maximum possible offset between the two clock signals. The equations for counter values of UE 702 and access server 708 are:

UE 702 Counter Value=T+offset′+ToF₁₂ Eq. [1]

UE 708 Counter Value=T+offset′−ToF₂₁ Eq. [2]

Where ToF₁₂ is the time of flight of the positive edge indication signal from UE 702 to access server 708 and ToF₂₁ is the time of flight of the positive edge indication signal from access server 708 to UE 702. T is the time period of pulse.
Adding Eq. [1] and Eq. [2] will result in:

UE 702 Counter Value+UE 708 Counter Value=2T+2offset′+ToF₁₂−ToF₂₁ Eq. [3]

Offset′ is the incorrect offset value due to the difference in time of flights.

offset′=(UE 702 Counter Value+UE 708 Counter Value−2T+ToF₁₂−ToF₂₁)/2 Eq. [4]

Whereas offset is the true offset value between the two clock signals.

offset′=(2offset+ToF₁₂−ToF₂₁)/2 Eq. [5]

In the above equations, T and counter values can be assumed to be known for computing the offset. Therefore, the only error that is inherent in the method of clock synchronization is due to the unknown difference of (ToF₁₂−ToF₂₁). In such a scenario, if CMSs have forwarded the positive edge indication signal after inserting T_{Arrival}, the ToF of signal for X2 722, X3 714, and X4 716 can be computed. Similarly, the ToF of signal for Y2 740, Y3 732, and Y4 736 can also be calculated. In an embodiment, serving CMS 720 of access server 708 should keep the record of ToF of positive edge indication signal for inter-satellite distances X2 722, X3 714 and X4 716; and serving CMS 718 of UE 702 should record the ToF for inter-satellite distances Y2 740, Y3 732 and Y4 736. Therefore, after two-way transfer of the positive edge indication signal between UE 702 and UE 706, serving CMS 718 and serving CMS 720 should transmit the value of ToF corresponding to the inter-satellite distances to either access server 708 or UE 702. The entity that is authenticating and computing the offset between the clock signals must subtract (X2+X3+X4)/c and add (Y2+Y3+Y4)/c in the sum of counter values given in Eq. [3]. The relationship between the real offset value and the incorrect offset value because of the error induced to the different ToF will be:

$$\begin{matrix}{offset}^{′} = \frac{2 offset + \frac{X 1 + X 5}{c} - \frac{Y 1 + Y 5}{c}}{2} & Eq . [ 6 ] \\ {offset}^{′} = \frac{2 offset + \frac{X 1 - Y 5}{c} + \frac{C 1 - Y 1}{c}}{2} & Eq . [ 7 ]\end{matrix}$$

FIG. 8 illustrates the method for computing the difference in distance between a UE and serving CMS because of the mobility of serving CMS in its orbit. In FIG. 8, r2 806 represents the position vector of UE 838 and r1 812 represents the position vector of serving CMS 830 of UE 838 when the serving CMS 830 has received the positive edge indication signal from its UE 838, where distances are computed in an earth centered inertial frame of reference. In FIG. 8, X-axis is represented by 832, Y-axis is represented by 836 and z-axis is represented by 834. The distance between UE 838 and serving CMS 830 can be computed as the difference (r2−r1) 810 between the position vector r2 806 of UE 838 and position vector r1 812 of serving CMS 830. In the example scenario of FIG. 8, the position vector r2 806 has an angle α 802 with the xy plane. The projection of position vector r2 806 onto xy-plane is |r2|cos(α) 840, whereas the projection of r2 806 along x-axis is |r2|cos(α)cos(β) 824, projection of r2 806 along y-axis is |r2|cos(α)sin(β) 822 and projection of r2 806 along z-axis is |r2|sin(α). β is the angle that vector r2 806 makes with the x-axis 832. In FIG. 8, it is assumed that the orbit of serving CMS 830 is along zy plane to facilitate formal modelling. Consequently, the position vector r1 812 does not have any projection along x-axis 832, as x-axis 832 is perpendicular to the zy-plane. Projection of vector r1 812 along z-axis 834 is |r1|cos(γ) 826 and y-axis is |r1|sin(γ). Therefore, the distance |r2−r1| is given as:

|r2−r1|=[((|r2|*cos(α)*cos(β))²+(|r2|*cos(α)*sin(β)−|r1|*sin(γ))²+(|r2|*sin(α)−|r1|*cos(γ))²]^{1/2} Eq. [8]

In FIG. 8, r1′ 814 is the position vector of the serving CMS 830 after some arbitrary time during which the position of serving CMS 830 is changed due to its orbital motion. Therefore, the distance between serving CMS 830 and UE 838 at this new position of serving CMS 830 is given as:

|r2−r1′|=[((|r2|*cos(α)*cos(β))²+(|r2|*cos(α)*sin(β)−|r1′|*sin(γ′))²+(|r2|*sin(α)−|r1′|*cos(γ′))²)]^{1/2} Eq [9]

Where γ′ 816 is the angle that r1′ 814 makes with the z-axis 834. The difference in the distance is therefore given as:

|(r2−r1)−(r2−r1′)|=[((r2|*cos(α)*cos(β))²+(|r2|*cos(α)*sin(β)−|r1|*sin(γ))²+(|r2|*sin(α)−|r1|*cos(γ))²]−sqrt[((|r2|*cos(α)*cos(β))²+(|r2|*cos(α)*sin(β)−|r1′|*sin(γ′))²+(|r2|*sin(α)−|r1′|*cos(γ′))²]^{1/2} Eq [10]

The models presented in the above use the fundamental mathematical equations well known to those skilled in the art.

The orbital time period of LEO satellites orbiting at an altitude of around 500 Km is approximately equal to 90 minutes. Therefore, the change in angle γ 820 denoted by Δγ 818 will be around ( 1/15)° during one second of time for a serving CMS orbiting at this altitude. For a scenario of FIG. 7, where multiple CMSs connect serving CMS 718 of UE 702 with serving CMS 720 access server 708, the ToF of positive edge indication signal from UE 702 to access server 708 may take up to a few milliseconds. To compute Δγ 818 for serving CMS 718, the system considers the time duration between the instant the positive edge indication signal of UE 702 is forwarded by serving CMS 718 to one of the other CMS s and the instant the positive edge indication signal of access server 708 is forwarded by serving CMS 718 to UE 702. Similarly, the system computes the Δγ 818 for serving CMS 720 during the instant the positive edge indication signal of UE 702 is forwarded by serving CMS 720 to access server 708 and the instant the positive edge indication signal of access server 708 is forwarded by serving CMS 720 to one of the other CMSs in the network.

In the example case of FIG. 7, the two-way transfer of the positive edge indication signal, the system assumes a delay of 3 milliseconds between the time instant the positive edge indication signal of UE 702 is forwarded from serving CMS 720 to access server 708 and the instant the positive edge indication signal of access server 708 is forwarded by serving CMS 720 to other CMSs. The time duration between the time instant the positive edge indication signal of UE 702 is forwarded by serving CMS 718 and the time instant the positive edge indication signal of LBS access server 708 is forwarded by serving CMS 718 to UE 702 is taken as 9 milliseconds. Therefore, the Δγ 818 corresponding to serving CMS 720 for a time duration of 3 millisecond is ((3/15)*0.001)° which is equal to 2*10⁻⁴ degrees and Δγ 818 corresponding to serving CMS 718 for a time duration of 9 millisecond is equal to 6*10⁻⁴ degrees.

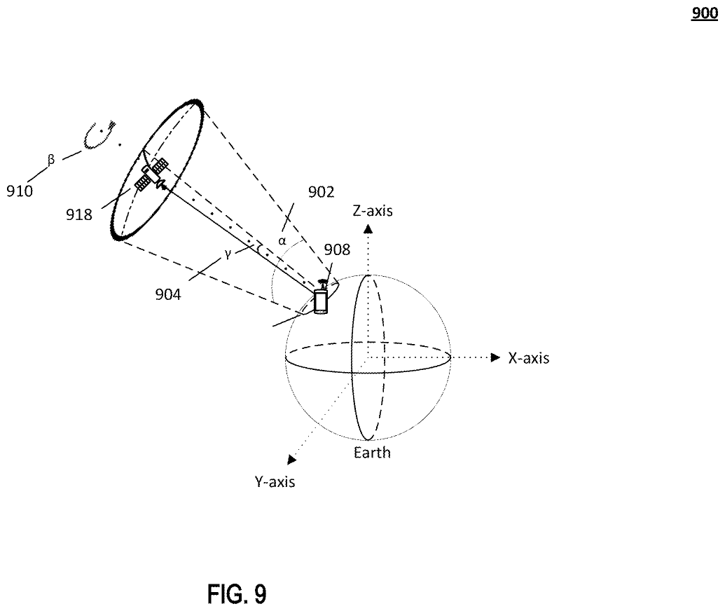

FIG. 9 illustrates the range of angles α 902, β 910 and γ 904 between UE 908 and serving CMS 918 that are used in the clock synchronization method and associated protocol as shown in eq. [9] and eq. [10]. Satellite 918 is orbiting closest to the position of UE 908 and hence acts as its serving CMS. Therefore, serving CMS 918 will have small α and γ angles relative to UE 908. Therefore, in FIG. 9, for the case of simplicity, it is assumed that serving CMS 918 has a small value of angle γ 904 from z-axis (i.e, in the range of −10° to +10°) and a small value of angle α 902 (i.e., in the range 80° to 100°) for UE 908. However, the value of angle β 910 can be in the range of 0° to 360° as shown in the FIG. 9. FIG. 9 aids in understanding of the clock synchronization method and associated protocol as shown in eq. [9] and eq. [10] to compute the bounds on the error in clock synchronization once it is transmitted over multiple hops from UE 702 to LBS access server 708 and vice versa.

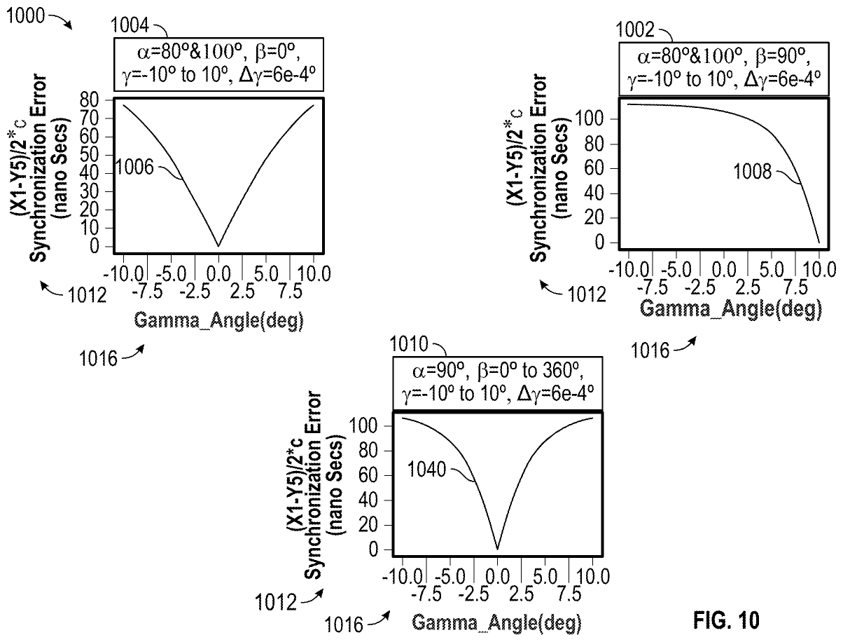

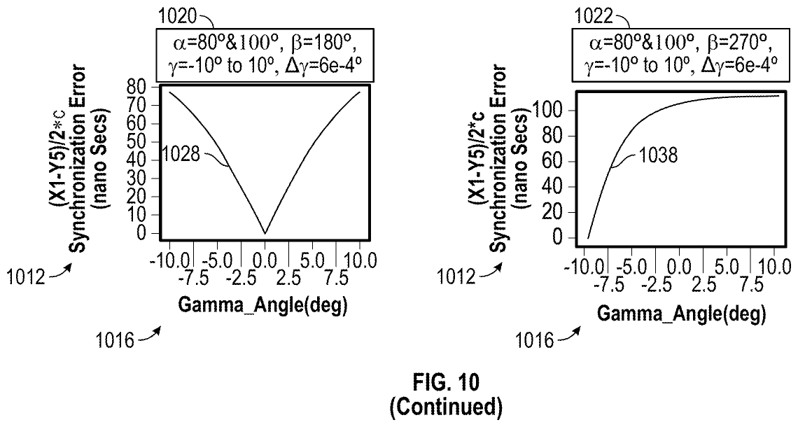

FIG. 10 shows the plots, obtained from the models mentioned in the above by the system, for the time duration (X1−Y5)/2*c used in computing the clock offset value in equation 7. 906 is the curve of |(X1−Y5)/2*c 912| for change in gamma angle Δγ 916=6*10⁻⁴° in the range of −10° to +10°, the value of angle beta β=0° and the value of angle α in the range of 80° to 100° as shown in 904. 908 is the curve of |(X1−Y5)/2*c 912| for change in gamma angle Δγ 916=6*10⁻⁴ in the range of −10° to +10°, the value of angle beta β=90° and the value of angle α in the range of 80° to 100° as shown in 902. 928 is the curve of value of |(X1−Y5)/2*c 912| for change in gamma angle Δγ 916=6*10⁻³° in the range of −10° to +10°, value of angle beta β=180° and value of angle a in the range of 80° to 100° as shown in 920. 938 is the curve of |(X1−Y5)/2*c 912| for change in gamma angle Δγ 916=6*10⁻⁴° in the range of −10° to +10°, the value of angle beta β=270° and the value of angle α in the range of 80° to 100° as shown in 902. 940 is the curve of |(X1−Y5)/2*c 912| for change in gamma angle Δγ 916=6*10⁻⁴° in the range of −10° to +10°, the value of angle beta β=0° to 360° and the value of angle α=90° as shown in 910. Curve 940 remains same for all values of angle beta β, therefore, in 910 the value of angle β is shown to be in the range of 0° to 360°.

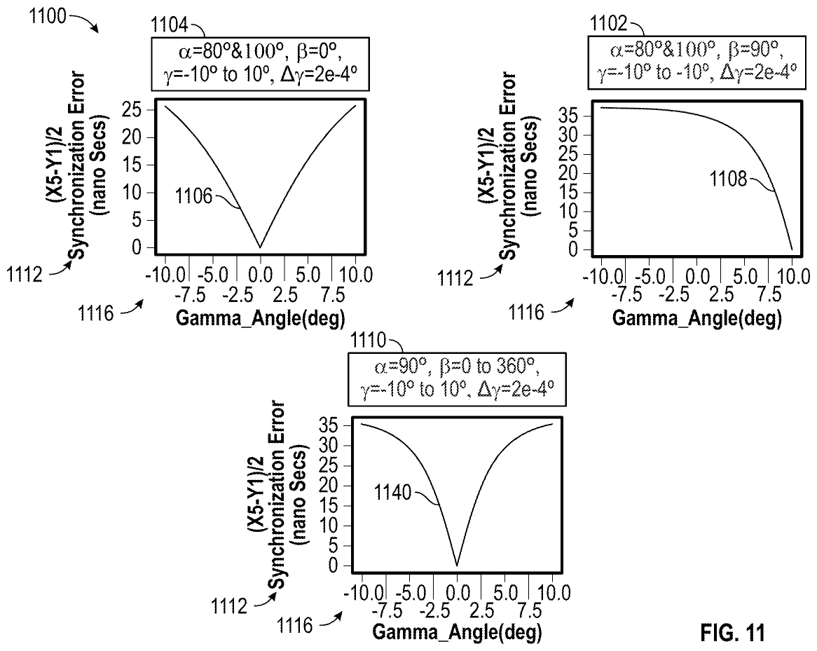

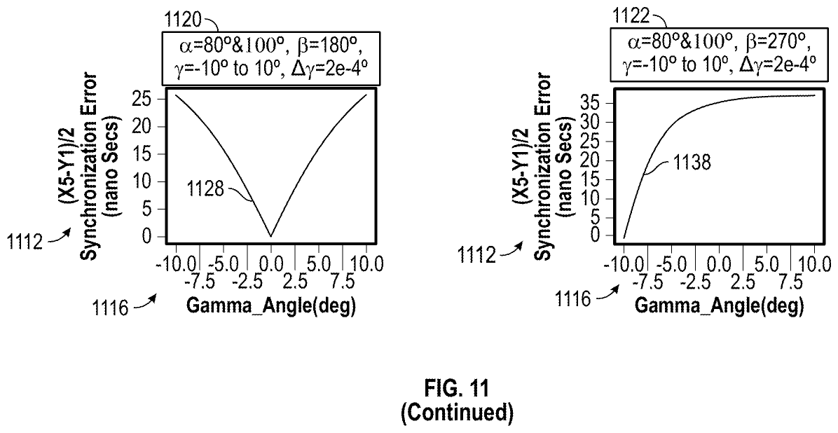

FIG. 11 shows the plots, obtained from the models mentioned in the above by the system, for the time duration (X5−Y1)/2*c used in computing the clock offset value in equation 7. 1006 is the curve of |(X5−Y1)/2*c 1012| for change in gamma angle Δγ 1016=2*10⁻⁴° in the range of −10° to +10°, the value of angle beta β=0° and the value of angle α in the range of 80° to 100° as shown in 1004. 1008 is the curve of |(X5−Y1)/2*c 1012| for change in gamma angle Δγ 1016=2*10⁻⁴ in the range of −10° to +10°, the value of angle beta β=90° and the value of angle α in the range of 80° to 100° as shown in 1002. 1028 is the curve of |(X5−Y1)/2*c 1012| for change in gamma angle Δγ 1016=2*10⁻⁴° in the range of −10° to +10°, the value of angle beta β=180° and the value of angle α in the range of 80° to 100° as shown in 1020. 1038 is the curve of |(X5−Y1)/2*c 1012| for change in gamma angle Δγ 1016=2*10⁻⁴° in the range of −10° to +10°, the value of angle beta β=270° and the value of angle α in the range of 80° to 100° as shown in 1002. 1040 is the curve of |(X1−Y5)/2*c 1012| for change in gamma angle Δγ 1016=2*10⁻⁴° in the range of −10° to +10°, the value of angle beta β=0° to 360° and the value of angle α=90° as shown in 1010. Curve 1040 remains the same for all values of angle beta β, therefore, in 1010 the value of angle β is shown to be in the range of 0° to 360°. The geolocation errors due to the clock offset values as a result of errors of time duration (X1−Y5)/2*c and (X1−Y5)/2*c for the presented example are bounded by 35 meters by using the trilateration method. The error is acceptable for many daily used LBS applications while the clock signals are transmitted over multiple hops between two UEs.

In an embodiment, this inaccuracy in computing the offset value between the clock signals is mitigated if the serving CMS computes the angle of arrival of the positive edge indication signal at its antenna and uses it to determine whether to add the time duration or to subtract the time duration in computing the clock offset value. The angle of arrival of a signal at the antenna of a satellite is computed using the methods disclosed in the prior art.

In another embodiment, the UE of a client user and the UE of an LBS provider follow a clock synchronization protocol with their respective ground stations. In such an embodiment, the clock signals of all ground stations are already synchronized.

In another embodiment, satellites may also be equipped with a SPE module. In such a scenario, UE 602 of a client user and access server 608 of an LBS provider synchronize their clock signals with their respective serving CMSs. It is assumed that the clock signals of CMSs are already synchronized among each other.

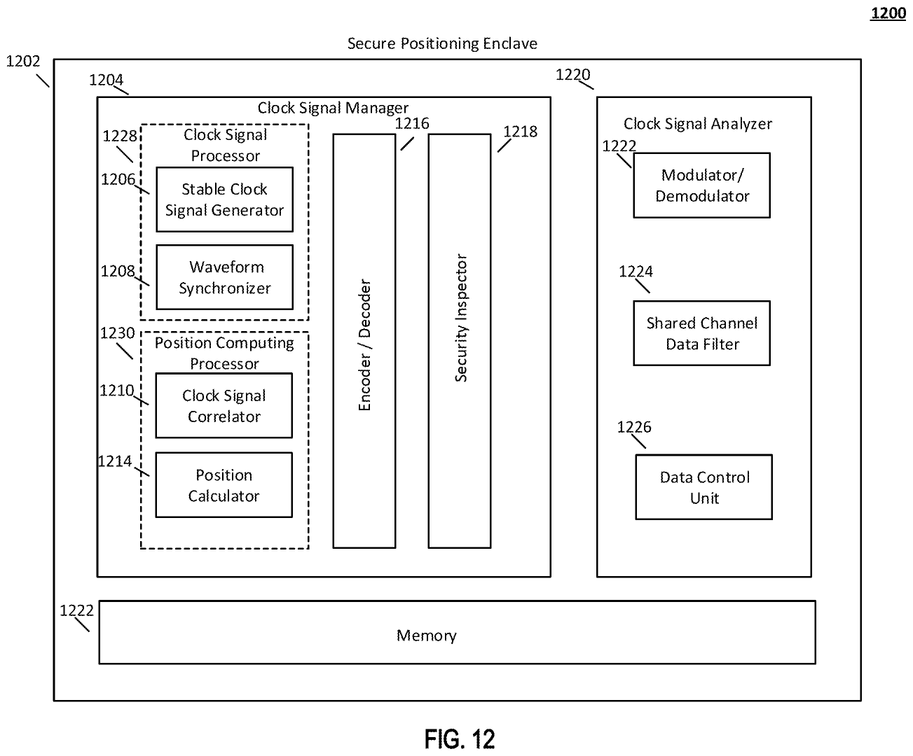

FIG. 12 is a functional block diagram of a SPE module 1202 that transmits the clock signal and computes the geolocation coordinates using the waveform of a received clock signal. SPE module 1202 is configured to enable it to compute the geolocation of an entity or a device that is the endpoint of a communication session. An instance of SPE module 1202 can be used by access server 608 of an LBS provider to calculate the geolocation of UE 602. Similarly, UE 602 can use an instance of SPE module 1202 to compute the geolocation of access server 608 of an LBS provider and then transmit its clock signal to access server 608 of an LBS provider, which may subsequently compute the geolocation of UE 602. SPE module 1202 is comprised of a clock signal manager (CSM) 1204, clock signal analyzer (CSA) 1220, and memory module 1222. Clock signal manager (CSM) 1204 of SPE module 1202 has clock signal processor (CSP) 1228, which itself might be compromised of a group of submodules that together are managing the clock signal and then transmitting it to access server 608 of an LBS provider.

In the embodiment, CSP 1228 has two modules: Stable clock signal generator (SCSG) 1206 and waveform synchronizer 1108, and their functions are explained in the co-pending U.S. patent application 63/322,760. This modified CSM 1204 also has a position computing processor (PCP) 1230 that computes the geolocation coordinates of an entity/UE/device communicating with it. PCP 1230 is comprised of two modules: Clock signal correlator 1210 and position calculator 1214. Clock signal correlator 1210 correlates the received clock signal with the clock signal generated by SCSG 1206 to compute the time of flight (ToF) of a signal that is transmitted by other entity of a communication endpoint. Position calculator 1214 uses ToF of signals, received from other entity, to compute its geolocation. Encoder/Decoder module 1216 encodes the signal from CSP 328 and decodes the signal that is used by PCP 1230. Security Inspector 1218 encrypts and decrypts the received signals. Clock signal analyzer (CSA) 1120 in SPE 1202 acquires the data of clock signals from shared physical channels and filters the data for the baseband processor by using a shared channel data filter 1224. Data control unit 1226 controls the data transmission and reception from SPE 1102 and baseband processor. Modulator/Demodulator module 1212 in CSA 1220 modulates/demodulates the clock signal data from CSP 1228 onto the physical channel during its transmission.

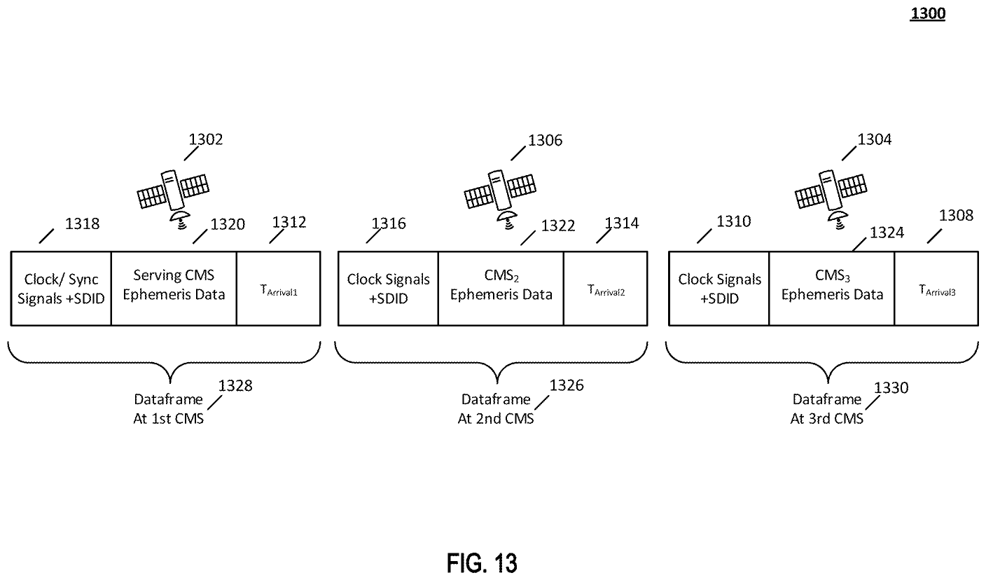

FIG. 13 illustrates an embodiment of the structure of the appended data-frames containing the clock signals or synchronization signals according to an aspect of disclosed concept. Each CMS that receives the clock signal or synchronization signals and <publicID,SDID>, adds time of arrival and ephemeris data to enable position computation entity to correctly compute the geolocation. Data-frame 1318 received at serving CMS 1302, is comprised of clock synchronization signals 620 along with <publicID, SDID> if offset between clock signals of UE 602 and access server 608 of an LBS provider is not yet computed. However, if the offset is already computed, then the data-frame 1318 received at serving CMS 1302 is comprised of clock signal 624 and <publicID,SDID>. Additionally, if the offset is already computed then the other CMS receive a data frame 1316, 1310 comprised of clock signal 624 and <publicID,SDID>. Data-frame 1328 at serving CMS is comprised of clock/sync signal and SDID block 1318, which contains signals transmitted by UE 602, time of arrival (T_{Arrival}) 1312 at serving CMS 1302, and its ephemeris data 1320. Two other CMSs, 1306 and 1304, also create data frames 1326 and 1330, respectively, comprised of clock signals and SDID 1316 and 1310, respectively, their T_{Arrival} 1314 and 1308, respectively, and their corresponding ephemeris data 1322 and 1324, respectively.

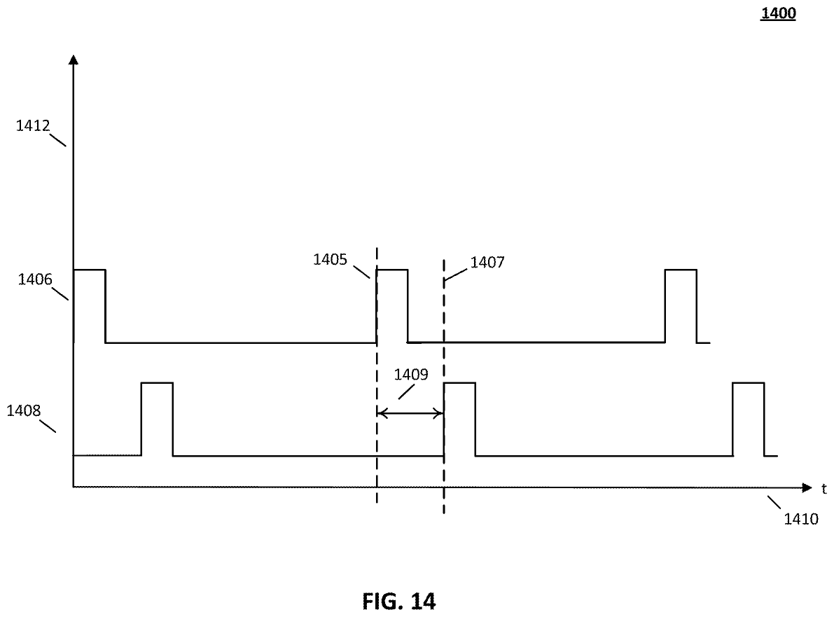

FIG. 14 illustrates a method, used by clock signal correlator 1210, to compute ToF by performing time delay analysis on clock signals transmitted by UE 602 to access server 608 of an LBS provider and vice versa. UE 602 transmits the clock signal to a minimum of three CMSs. Clock signal and <publicID,SDID> 624 of UE 602 is then transmitted, after appending it with the time of arrival and ephemeris data, by the CMSs to access server 608 of an LBS provider. Three such clock signals from three different CMSs are received by access server 608 of an LBS provider and are time-delayed with reference to a clock signal generated by SCSG 1206 of access server 608 of an LBS provider. The time delay analysis of three waveform signals enables access server 608 of an LBS provider to compute three ToFs. The computation of ToF of a clock signal that is received at access server 608 of an LBS provider is illustrated. In FIG. 14, for the purpose of clarity, the waveform signals and axes are labeled with even numbers, while other information elements are labeled with odd numbers. Signal 1406 is the clock signal generated by SCSG 1206 of access server 608 of an LBS provider whereas the signal 1408 is the clock signal of UE 602 received at access server 608 of an LBS provider via CMSs. The difference 1409 between the positive edge 1405 of clock signal 1406 and positive edge 1407 of clock signal 1408 represent the time duration between the instant the clock signal was transmitted by UE 602 and the instant it is received in the SPE module of access server 608 of an LBS provider plus the initial offset between the two clock signals before transmission of signal 1408 from UE 602. The geolocation in this method is computed using the information of three time of flights of clock signal from UE 602 to three CMSs that directly received the clock signal. Therefore, the initial offset and the time duration between the instant the appended clock signal transmitted from CMS, that directly received the clock signal, and the instant the signal is received at SPE module of access server 608 of an LBS provider, must be subtracted from time duration 1409.

It is assumed that access server 608 of an LBS provider has already computed the offset between the clock signal of UE 602 and its own clock signal using the two-way transfer of positive edge indication signal described in FIG. 7. ToF from UE 602 to ith CMS that directly received the clock signal is computed as:

ToF_{UE_to_ith_CMS}=|time delay 1309−offset−(T_{Arrival_at_LBS_provider_of_UE}−T_{Arrival_at_ith_CMS})| Eq. [11]

T_{Arrival_at_ith_CMS} is the time of arrival of a signal at one of the ith CMS that directly receives clock signal from UE 602. The offset in the above equation is the time offset between clock signal of UE 602 and an access server 608 of an LBS provider.

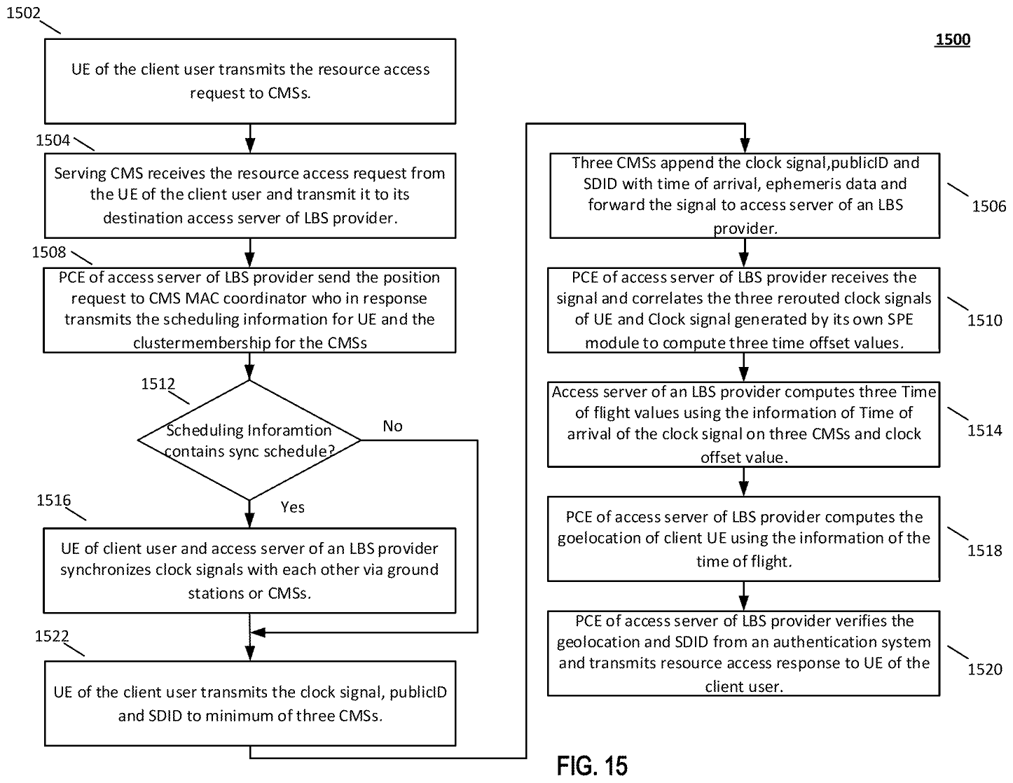

FIG. 15 describes the flow graph of a method for computing geolocation coordinates of UE 602 by an access server 608 of an LBS provider using a system in which UE 602 and access server 608 of an LBS provider are equipped with SPE module 1102. In step 1502, UE 602 transmits resource access request 612 to serving CMS 604. In step 1504, serving CMS 604 receives the resource access request 612 from UE 602 and transmits it to access server 608 of an LBS provider. In step 1508, access server 608 of an LBS provider transmits position request 614 to CMS MAC coordinator 610. CMS Mac Coordinator 610 determines the cluster membership and scheduling information for UE 602 and transmit it in a message 616 to serving CMS 604 and other CMSs 606. If scheduling information 618 contains clock synchronization schedule in step 1512, UE 602 and access server 608 of an LBS provider synchronizes clock signals with each other by the forwarded clock synchronization signals 620, for instance using two transfer method described in co-pending patent application 63/322,720, via CMSs in step 1516 or with their ground stations. If scheduling information 618 does not contain clock synchronization schedule in step 1512, UE 602 skips step 1516 and transmits the clock signal and its<publicID,SDID> 624 to a minimum of three CMSs in step 1522. In step 1506, three CMSs combine the clock signal and <publicID,SDID> with time of arrival and ephemeris data and transmit data-frames 628 and 630 to an access server 608 of an LBS provider. Access server 608 of an LBS provider receives the messages and correlates the three clock signals from signals 628 and 630 of UE 602 and clock signal generated by its own SPE module 1202 to compute three different time offset values in step 1510. In step 1514, access server 608 of an LBS provider computes three time of flight values using the information of time of arrival of the clock signal on three CMS s and clock offset value. In step 1518, position calculator 1214 of an access server 608 of an LBS provider computes the geolocation of UE 602 using the information of the time of flight. Access server 608 of an LBS provider verifies the geolocation and SDID from an authentication system 638 and transmits resource access response 636 to UE 602 in step 1520.

What is claimed:

1. A system for determining a geolocation of user equipment (UE) of a client in order to grant or deny access to resources of a location-based service provider, comprising:
a first node structured and configured to receive a positioning signal from the UE, determine a first time of arrival of the positioning signal at the first node, and determine first ephemeris data of the first node at the first time of arrival;
a second node structured and configured to receive the positioning signal from the UE, determine a second time of arrival of the positioning signal at the second node, and determine second ephemeris data of the second node at the second time of arrival;
a third node structured and configured to receive the positioning signal from the UE, determine a second time of arrival of the positioning signal at the second node, and determine second ephemeris data of the second node at the second time of arrival; and
an access server of the location-based service provider, the access server being structured and configured to determine the geolocation of the UE based on the positioning signal from the UE, the first time of arrival, the first ephemeris data, the second time of arrival, the second ephemeris data, the third time of arrival and the third ephemeris data using a trilateration method.

2. The system according to claim 1, wherein the first node, the second node and the third node is each a satellite in a communication system.

3. The system according to claim 1, wherein the first node is also structured and configured to append a Tx Time Advance to a signal including the positioning signal, the first time of arrival and the first ephemeris data, and wherein the access server further uses the Tx Time Advance to determine the geolocation of the UE.

4. The system according to claim 1, wherein the access server is further structured and configured to grant or deny access to resources based on an authentication status received from a ground-based authentication system by executing a suitable immutable-factor based authentication procedure between the access server and the authentication system.

5. The system according to claim 4, wherein the UE is structured and configured to compute geolocation coordinates of the access server to securely authenticate the access server.

6. The system according to claim 5, wherein the access server is structured and configured to transmit an authentication signal to the UE through a communication system of a non-terrestrial network in which satellite nodes transmit the authentication signal by appending information of time of arrival of the authentication signal at one of the satellite nodes and ephemeris data of the one of the satellite nodes to the authentication signal.

7. The system according to claim 1, wherein the geolocation of the UE is determined using a Time Difference of Arrival (TDOA) method.

8. The system according to claim 1, wherein the positioning signal, the first time of arrival, the first ephemeris data, the second time of arrival, the second ephemeris data, the third time of arrival and the third ephemeris data are received by the access server in a single dataframe.

9. A system for determining a geolocation of user equipment (UE) of a client in order to grant or deny access to resources of a location-based service provider, comprising:
an access server of the location-based service provider, the access server being structured and configured to:
receive a positioning signal from the UE;
receive a first time of arrival of the positioning signal at a first node of a communications system, and first ephemeris data of the first node at the first time of arrival;
receive a second time of arrival of the positioning signal at a second node of the communications system, and second ephemeris data of the second node at the second time of arrival;
receive a third time of arrival of the positioning signal at a third node of the communications system, and third ephemeris data of the third node at the third time of arrival;
determine the geolocation of the UE based on the positioning signal, the first time of arrival, the first ephemeris data, the second time of arrival, the second ephemeris data, the third time of arrival and the third ephemeris data using a trilateration method.

10. The system according to claim 9, wherein the first node, the second node and the third node is each a satellite in the communication system.

11. The system according to claim 9, wherein the first node is structured and configured to append a Tx Time Advance to a signal including the positioning signal, the first time of arrival and the first ephemeris data, and wherein the access server further uses the Tx Time Advance to determine the geolocation of the UE.

12. The system according to claim 9, wherein the access server is further structured and configured to grant or deny access to resources based on an authentication status received from a ground-based authentication system by executing a suitable immutable-factor based authentication procedure between the access server and the authentication system.

13. The system according to claim 12, wherein the access server is structured and configured to transmit an authentication signal to the UE through a communication system of a non-terrestrial network in which satellite nodes transmit the authentication signal by appending information of time of arrival of the authentication signal at one of the satellite nodes and ephemeris data of the one of the satellite nodes to the authentication signal.

14. The system according to claim 9, wherein the geolocation of the UE is determined using a Time Difference of Arrival (TDOA) method.

15. The system according to claim 9, wherein the positioning signal, the first time of arrival, the first ephemeris data, the second time of arrival, the second ephemeris data, the third time of arrival and the third ephemeris data are received by the access server in a single dataframe.

16. A method of determining a geolocation of user equipment (UE) of a client in order to grant or deny access to resources of a location-based service provider, comprising:
receiving in an access server of the location-based service provider a positioning signal of the UE;
receiving in the access server a first time of arrival of the positioning signal at a first node of a communications system, and first ephemeris data of the first node at the first time of arrival;
receiving in the access server a second time of arrival of the positioning signal at a second node of the communications system, and second ephemeris data of the second node at the second time of arrival;
receiving in the access server a third time of arrival of the positioning signal at a third node of the communications system, and third ephemeris data of the third node at the third time of arrival; and
determining in the access server a geolocation of the UE based on the positioning signal, the first time of arrival, the first ephemeris data, the second time of arrival, the second ephemeris data, the third time of arrival and the third ephemeris data using a trilateration method.

17. The method according to claim 16, wherein the first node, the second node and the third node is each a satellite in the communication system.

18. The method according to claim 16, wherein the first node is structured and configured to append a Tx Time Advance to a signal including the positioning signal, the first time of arrival and the first ephemeris data, and wherein the access server further uses the Tx Time Advance to determine the geolocation of the UE.

19. The method according to claim 16, further comprising granting or denying in the access server access to resources based on an authentication status received from a ground-based authentication system by executing a suitable immutable-factor based authentication procedure between the access server and the authentication system.

20. The method according to claim 19, further comprising transmitting from the access server an authentication signal to the UE through a communication system of a non-terrestrial network in which satellite nodes transmit the authentication signal by appending information of time of arrival of the authentication signal at one of the satellite nodes and ephemeris data of the one of the satellite nodes to the authentication signal.

21. The method according to claim 16, wherein the geolocation of the UE is determined using a Time Difference of Arrival (TDOA) method.

22. The method according to claim 16, wherein the positioning signal, the first time of arrival, the first ephemeris data, the second time of arrival, the second ephemeris data, the third time of arrival and the third ephemeris data are received by the access server in a single dataframe.

23. The method according to claim 16, wherein only the UE or the access server are equipped with a secure positioning enclave module and wherein the geolocation of the UE is computed by also using clock signal(s) generated from a secure positioning module of the access server.

24. The method according to claim 16, wherein synchronization of clock signals of the UE and of the access server is done using signals routed by a network of CMS s.

25. The method according to claim 16, wherein the UE and the access server synchronize their respective clock signals with their respective ground stations.

26. A method of determining a geolocation of user equipment (UE) of a client in order to grant or deny access to resources of a location-based service provider, comprising:
receiving in a first node a positioning signal from the UE, and determining a first time of arrival of the positioning signal at the first node and first ephemeris data of the first node at the first time of arrival;
receiving in a second node the positioning signal from the UE, and determining a second time of arrival of the positioning signal at the second node and second ephemeris data of the second node at the second time of arrival;
receiving in a third node the positioning signal from the UE, and determining a second time of arrival of the positioning signal at the second node and second ephemeris data of the second node at the second time of arrival; and
providing to an access server of the location-based service provider the positioning signal from the UE, the first time of arrival, the first ephemeris data, the second time of arrival, the second ephemeris data, the third time of arrival and the third ephemeris data, the access server being structured and configured to determine the geolocation of the UE based on the received positioning signal, the first time of arrival, the first ephemeris data, the second time of arrival, the second ephemeris data, the third time of arrival and the third ephemeris data using a trilateration method.

27. The method according to claim 26, wherein the first node, the second node and the third node is each a satellite in the communication system.

28. The method according to claim 26, wherein the first node is structured and configured to append a Tx Time Advance to a signal including the positioning signal, the first time of arrival and the first ephemeris data, and wherein the access server further uses the Tx Time Advance to determine the geolocation of the UE.

29. The method according to claim 26, wherein the geolocation of the UE is determined using a Time Difference of Arrival (TDOA) method.

30. The method according to claim 26, wherein the positioning signal, the first time of arrival, the first ephemeris data, the second time of arrival, the second ephemeris data, the third time of arrival and the third ephemeris data are received by the access server in a single dataframe.
